(19) United States
(12) Patent Application Publication
(10) Pub. No.: US 2009/0185793 A1
(43) Pub. Date: Jul. 23, 2009

(54) Information Record and Reproduction Device

(76) Inventors: Akihiro GOTO, Hitachinaka (JP); Eisuke Sengoku, Hitachinaka (JP); Shinichi Ishikuro, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/354,025

(22) Filed: Jan. 15, 2009

(30) Foreign Application Priority Data
Jan. 18, 2008 (JP) 2008-009632

(51) Int. Cl. H04N 7/26

(52) U.S. Cl. 386/124; 386/E05.001

(57) ABSTRACT

An information record and reproduction device that records and/or reproduces information from both a hard disk and a card-shaped recording medium, the information record and reproduction device including a housing, a hard disk drive arranged in the housing, and a connector for a card-shaped recording medium, arranged in the housing. A side of the housing defines a grip portion being grasped by a user, and the connector for a card-shaped recording medium is arranged toward the grip portion relative to the hard disk drive.

### INCORPORATION BY REFERENCE

The present application claims priority from Japanese application JP2008-009632 filed on Jan. 18, 2008, the content of which is hereby incorporated by reference into this application.

### BACKGROUND OF THE INVENTION

The present invention relates to an information record and reproduction device that records and/or reproduces information from both a hard disk and a card-shaped recording medium.

As measures for radiating heat generated from circuit parts, such as LSI, etc., mounted on a circuit board in a video camera, there has been conventionally proposed a construction, in which a radiating plate, such as copper plate, etc., having an excellent thermal conductivity is connected to a metallic frame, which constitutes a framework of an information record and reproduction device, to radiate heat to an external housing and a radiating rubber is connected between the radiating plate and the circuit board to achieve an improvement in heat radiating property. Also, in recent years, image pickup devices and circuit boards are increased in heating value as video cameras are heightened in resolution picture. On the other hand, miniaturization of a whole device is demanded as far as possible.

For example, as an information record and reproduction device, of which miniaturization is taking into consideration, there is proposed a construction, in which an opening and closing lid is provided on a receiving section, in which a disk-shaped recording medium is received in a mountable and dismountable manner, and a lid body is provided on the opening and closing lid whereby a memory card receiving section is provided inside the lid, which defines a dead space (for example, JP-A-2007-158753).

Also, as a printed board holding construction capable of making a housing thin, there is proposed a construction, in which a first guide member having a tapered surface for guiding the printed board in a left and right direction when the printed board is placed on an object member and a second guide member having a tapered surface for guiding the printed board downward when the printed board after the placement is slid in a longitudinal direction are provided on the object member (for example, JP-A-2001-291978).

### SUMMARY OF THE INVENTION

JP-A-2007-158753 discloses a technology, in which with a view to attaining miniaturization of an information record and reproduction device using a disk-shaped recording medium, such as optical disk, etc., and a card-shaped recording medium such as memory card, etc. as a recording medium for recording and/or reproducing of information, a memory card receiving section is provided on an opening and closing lid provided on a receiving section, in which the disk-shaped recording medium is received. However, there is in no way disclosed a construction for miniaturization of an information record and reproduction device, in which a hard disk and a card-shaped recording medium are used as a recording medium. Also, no mention is made of measures for radiating heat generated in the device.

With the printed board holding construction described in JP-A-2001-291978, when a printed board is fixed to a chassis by the first guide member and the second guide member, the first guide member and the second guide member project from a surface of the printed board opposite to the chassis, so that there is a need of ensuring a space, in which the projecting portion is received, in the housing. However, such space is not made an effective use of and so becomes an obstacle to miniaturization. Also, there is a need of forming tapered surfaces on the first guide member and the second guide member, which serve to fix the printed board, so that manufacture is complex in terms of formation with a metallic frame.

The present invention has been thought of in view of these circumstances and has its object to provide an information record and reproduction device that can record and/or reproduce information from both a hard disk and a card-shaped recording medium, can inhibit the card-shaped recording medium from being influenced by heat generated in housing, and attains miniaturization.

The invention provides an information record and reproduction device that records and/or reproduces information from both a hard disk and a card-shaped recording medium, the information record and reproduction device comprising a housing, a hard disk drive arranged in the housing, and a connector for a card-shaped recording medium, arranged in the housing, and wherein a side of the housing defines a grip portion being grasped by a user, and the connector for a card-shaped recording medium is arranged toward the grip portion relative to the hard disk drive.

The information record and reproduction device according to the invention can record and/or reproduce information from both a hard disk and a card-shaped recording medium, inhibit the card-shaped recording medium from being influenced by heat generated in the housing, and attain miniaturization.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view showing an outward appearance of an information record and reproduction device according to the invention;

FIG. 2 is a perspective view showing a state, in which an opening and closing cover is dismounted from the information record and reproduction device shown in FIG. 1;

FIG. 3 is a left side view showing a state, in which a housing and a part of parts of the information record and reproduction device shown in FIG. 1 are dismounted;

FIG. 4 is a plan view showing the information record and reproduction device shown in FIG. 3;

FIG. 5 is a view showing the information record and reproduction device shown in FIG. 3 as viewed from the rear side;

FIG. 6 is a perspective view showing the information record and reproduction device shown in FIG. 3;

FIG. 7 is a view showing a state, in which a HDD is mounted to the information record and reproduction device shown in FIG. 6;

FIG. 8 is a view showing a state, in which the HDD is mounted to the information record and reproduction device shown in FIG. 5;

FIG. 9 is a view showing the information record and reproduction device shown in FIG. 8 as viewed from the front side;

FIG. 10 is a perspective view showing a state, in which the housing of the information record and reproduction device shown in FIG. 1 is dismounted;

FIG. 11 is a right side view showing the information record and reproduction device shown in FIG. 10;

FIG. 12 is a plan view showing the information record and reproduction device shown in FIG. 11;

FIG. 13 is a view showing the information record and reproduction device shown in FIG. 10 as viewed from the rear side;

FIG. 14 is a perspective view showing the HDD mounted on the information record and reproduction device shown in FIG. 1;

FIG. 15 is a perspective view showing the HDD shown in FIG. 14 as viewed from an opposite side;

FIG. 16 is a perspective view showing an SD card unit mounted on the information record and reproduction device shown in FIG. 6;

FIG. 17 is a right side view showing the SD card unit shown in FIG. 16;

FIG. 18 is a right side view showing a part of the information record and reproduction device shown in FIG. 2;

FIG. 19 is a partial, cross sectional view taken along the line XIX-XIX in FIG. 18;

FIG. 20 is an enlarged view showing a part indicated by broken lines in FIG. 19; and

FIG. 21 is a view showing the information record and reproduction device shown in FIG. 1 as viewed from the rear side.

### DESCRIPTION OF THE EMBODIMENTS

Subsequently, an embodiment of an information record and reproduction device according to the invention will be described with reference to the drawings. An embodiment described later is exemplary of the invention and the invention is not limited only to the embodiment. Accordingly, the invention can be embodied in various configurations as far as they do not depart from the gist thereof.

In addition, for the sake of making an explanation understandable, the accompanying drawings depict respective members in a state of not agreeing with actual ones in thickness, size, magnification, etc. Also, a side of a photographer at the time of photographing is referred below to as “rear side” and a side directed toward a subject at the time of photographing is referred below to as “front side” in the specification of the present application. Further, the right side on the photographer's right is referred below to as “right” and the left side on the photographer's left is referred below to as “left” in the specification of the present application. Also, a vertical direction of the device indicates a vertical direction at the time of photographing.

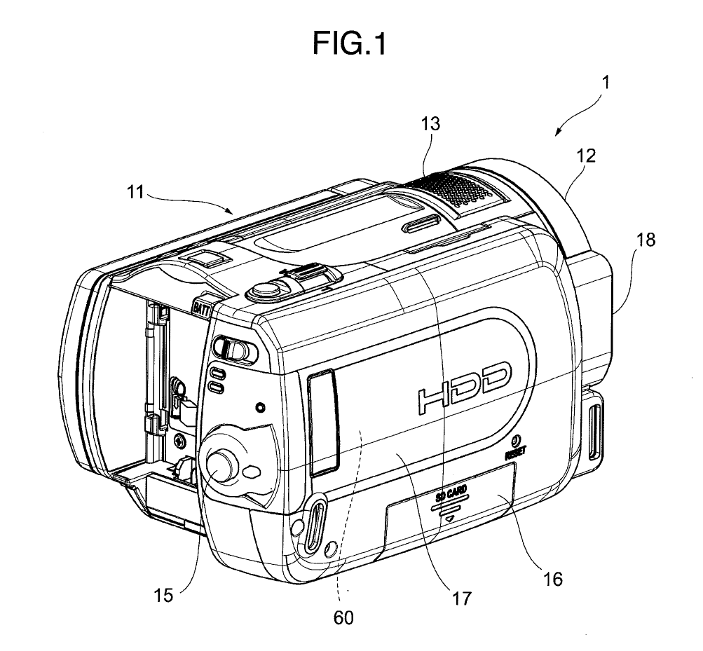

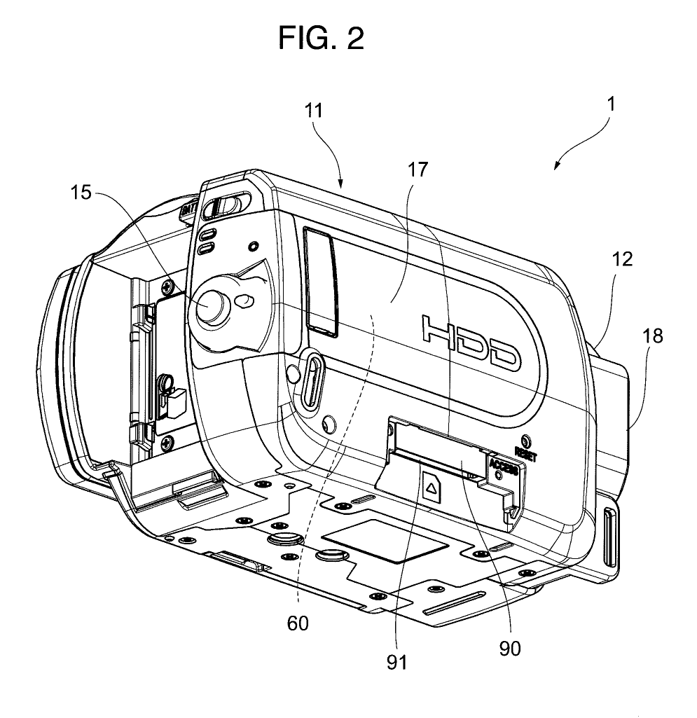

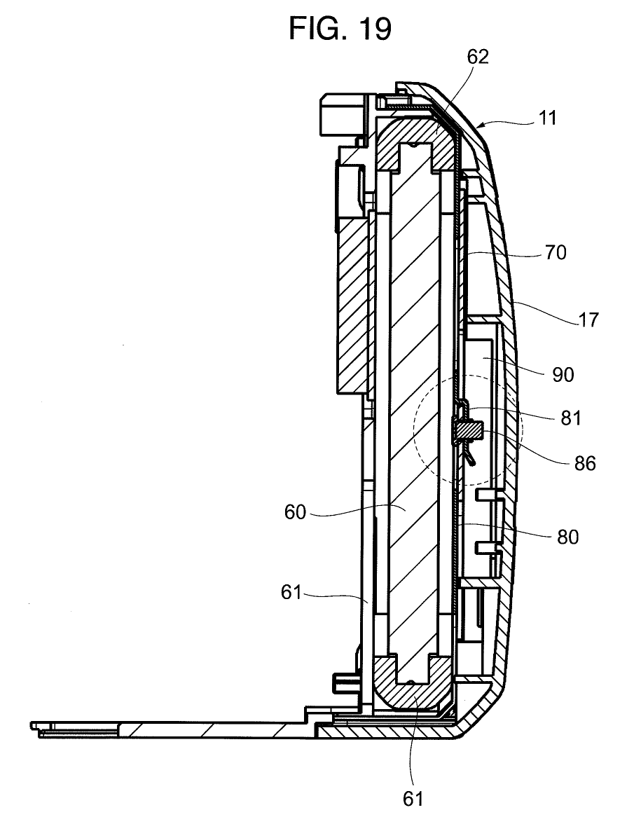

As shown in FIGS. 1 and 2, an information record and reproduction device 1 (for example, a video camera) includes a housing 11 that constitutes an outer packaging. The housing 11 is sized to enable a photographer to grasp and manipulate it in one hand and a right side of the housing 11 defines a grip portion 17 curved outward to be easily grasped by the photographer (see FIGS. 1, 2, and 19).

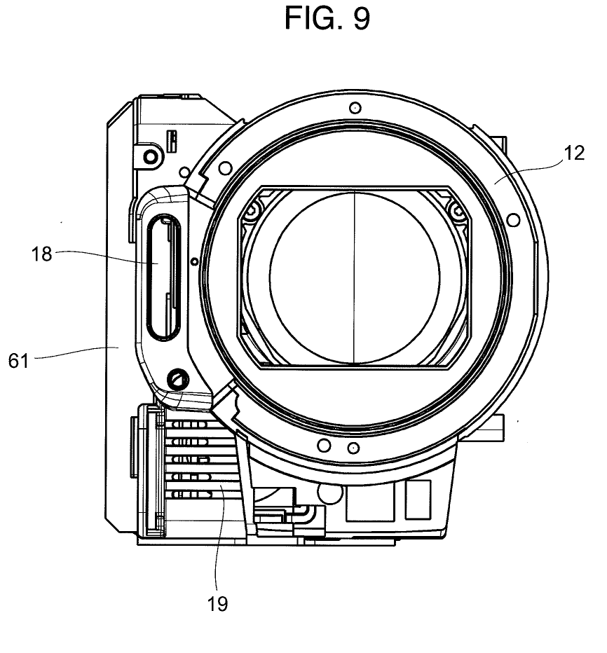

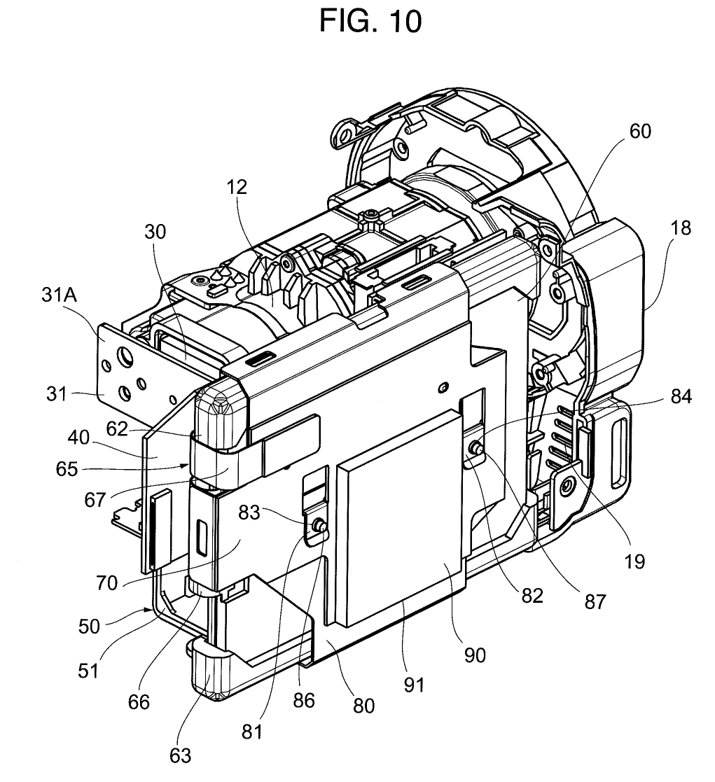

A lens-barrel 12 with a photographing optical system assembled thereinto is extended longitudinally on an upper portion of the housing 11 on the front side. A microphone 13 for sound acquisition is arranged adjacent to a rear of an upper portion of the lens-barrel 12. A flush 18 used when a still image is photographed in a dark place is arranged on the front side of the upper portion of the housing 11 and adjacent to a front portion of the lens-barrel 12. Further, an exhaust port 19 (see FIGS. 9 and 10), through which an air flow generated by a cooling fan 50 described later in detail is discharged, is formed below the flush 18 on the front side of the housing 11.

A recording button 15 for beginning and stopping the recording is provided on the rear side of the housing 11.

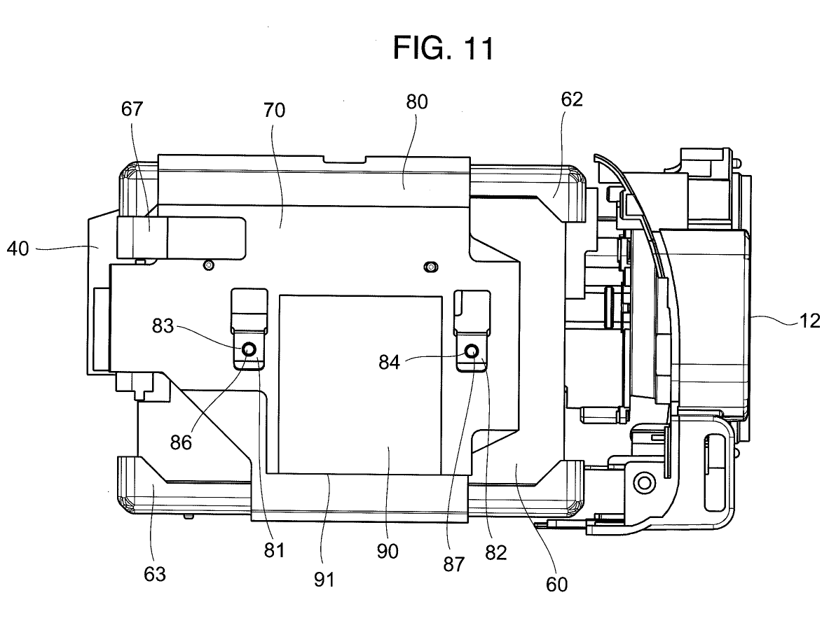

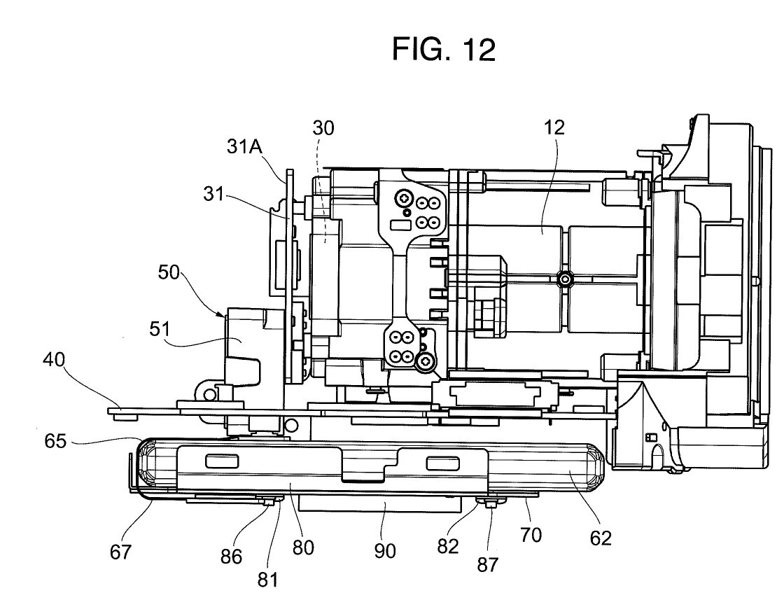

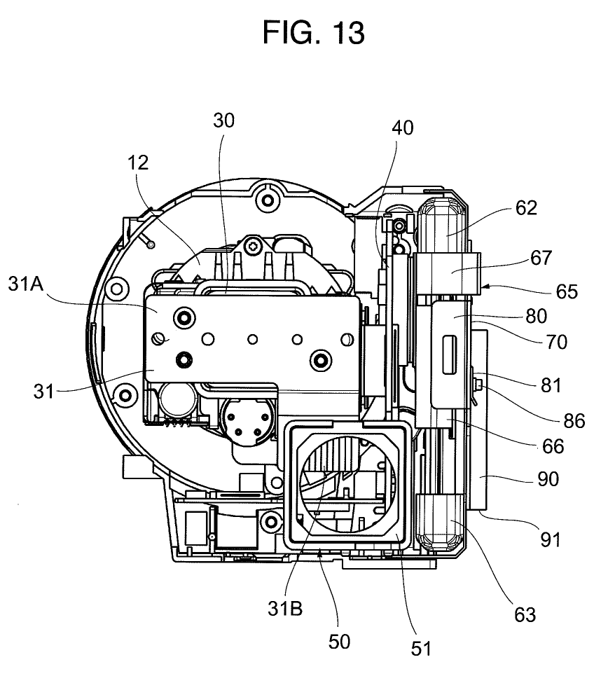

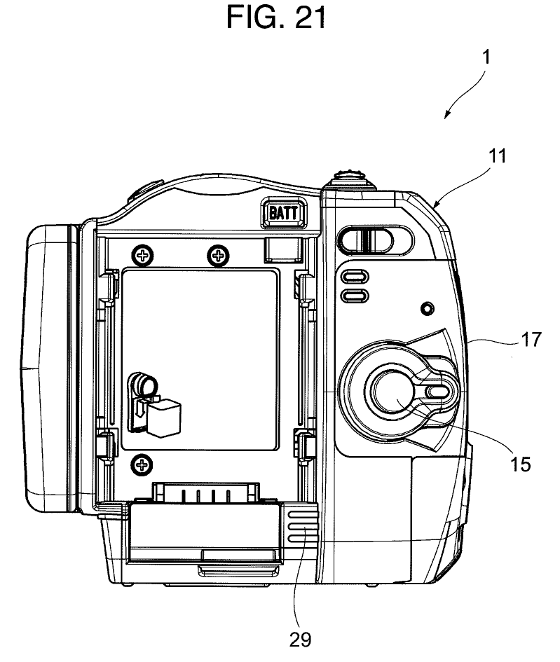

Provided on the right side of the housing 11 is an opening and closing cover 16 opened or closed when an SD card as a card-shaped recording medium is inserted into or pulled out from an SD connector 90 (see FIGS. 2, 10 to 13, etc.) arranged in the housing 11. Further, an air intake port 29, through which an air is taken into the housing 11, is formed below the rear side of the housing 11 as shown in FIG. 21.

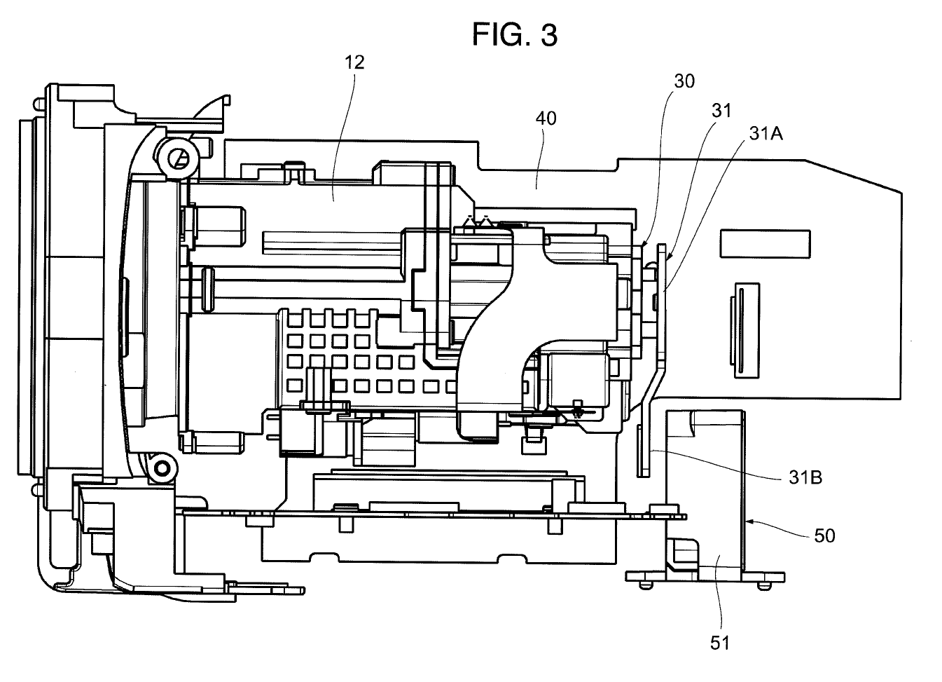

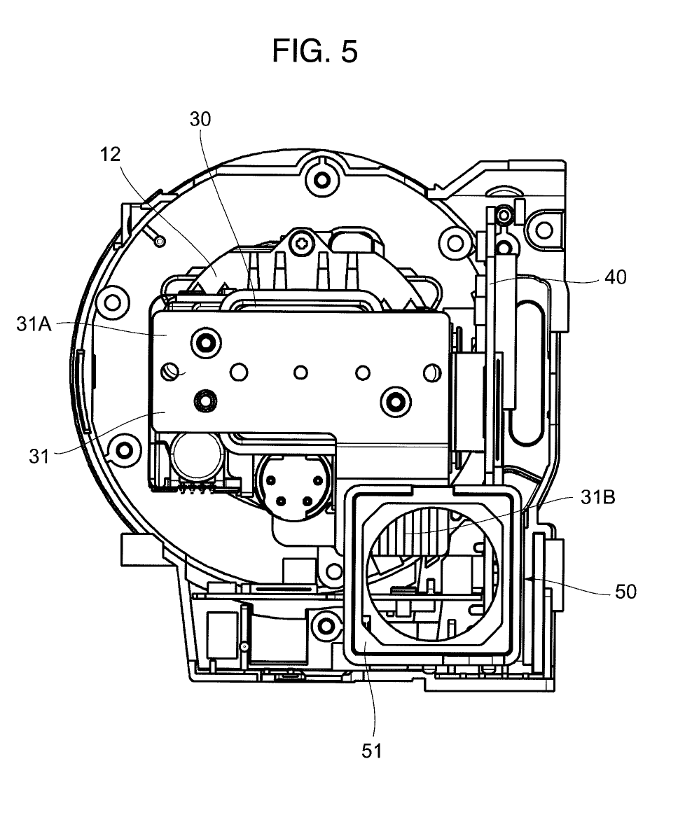

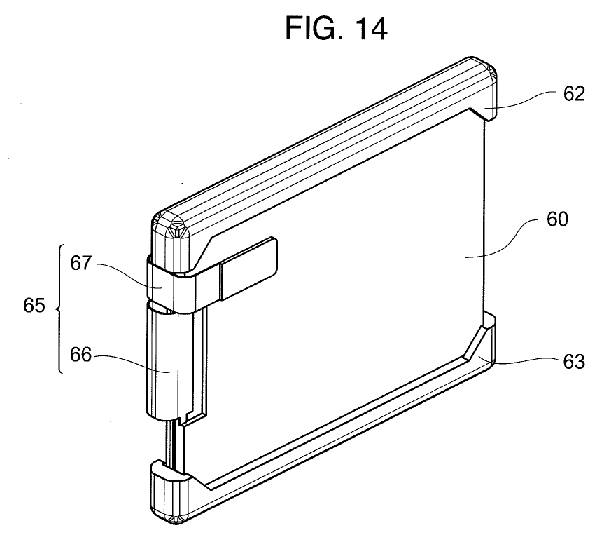

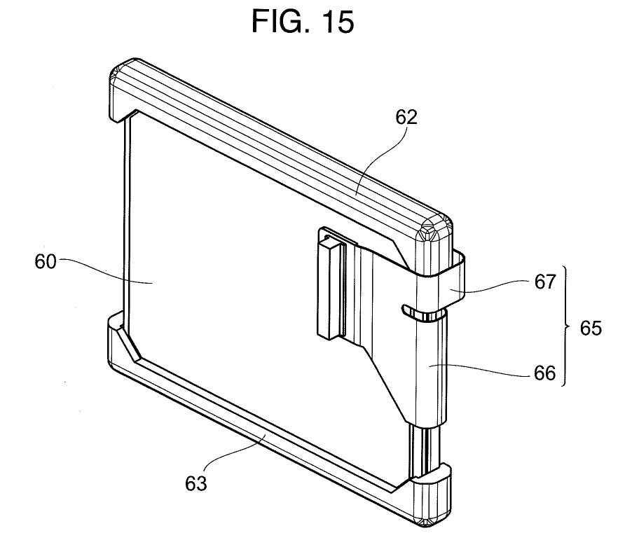

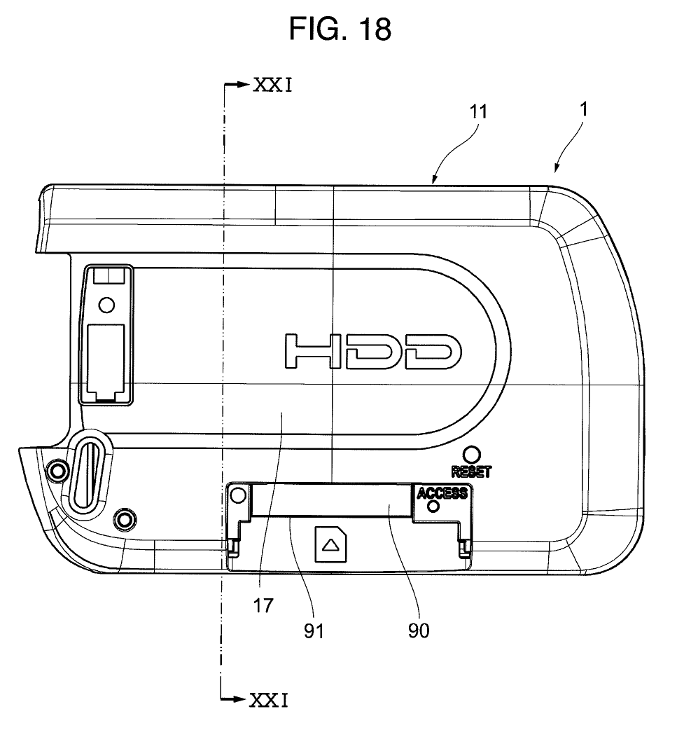

Subsequently, an internal structure of the housing 11 will be described with reference to FIGS. 3 to 20. The lens-barrel 12 in a state of extending in a longitudinal direction is arranged in the housing 11 and an image pickup device 30 (see FIGS. 3 to 6, etc.) that images a subject image conducted by the photographing optical system is provided on a rear side end of the lens-barrel 12. Further, a radiating plate 31 being a radiating member that radiates heat generated by the image pickup device 30 is arranged behind the image pickup device 30. In particular, as shown in FIG. 5, a plane (surface) of the radiating plate 31 as viewed from the rear side is substantially L-shaped, one end 31A of the substantially L-shaped configuration being positioned on the left, and the other end 31B being positioned on a lower side (see FIGS. 3 to 6, etc.). In addition, the radiating plate 31 is arranged such that the plane (surface) thereof as viewed from the rear side is made substantially parallel to a left and right direction of the information record and reproduction device 1, and in particular, the other end 31B is bent to be positioned toward the front side relative to the one end 31A as shown in FIG. 3.

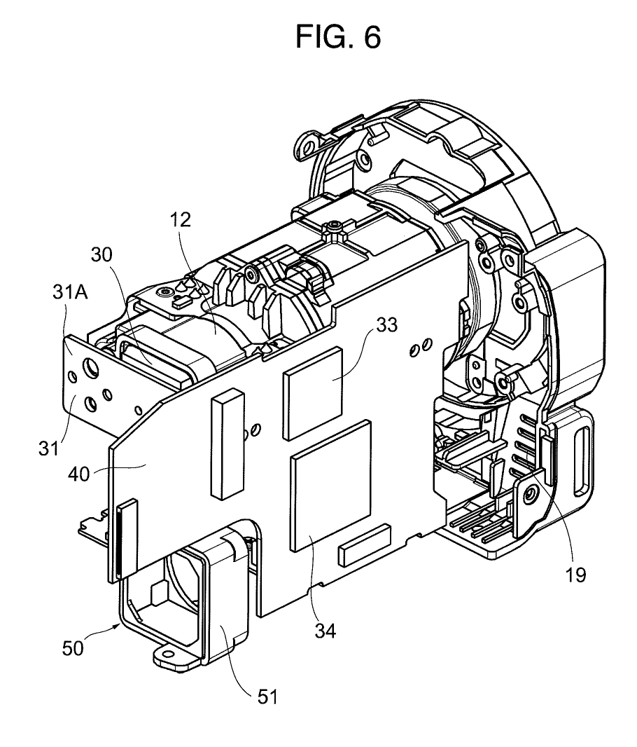

A main circuit board 40, on which an integrated circuit such as a signal processing circuit 33 for forming a screen image from a signal obtained from the image pickup device 30, a coding-decoding circuit 34 for coding and decoding the screen image, etc. is mounted, is arranged on the right of the lens-barrel 12, the image pickup device 30, and the radiating plate 31 (FIG. 6). As shown in FIGS. 3 to 6, the main circuit board 40 is arranged so that a plane (surface) thereof as viewed from the right side is made substantially parallel to the longitudinal direction of the information record and reproduction device 1. Further, the main circuit board 40 is shaped so that a lower portion thereof on the rear side is cut to be substantially rectangular-shaped and a space is defined between a bottom of the housing 11 and the rear side of the main circuit board 40.

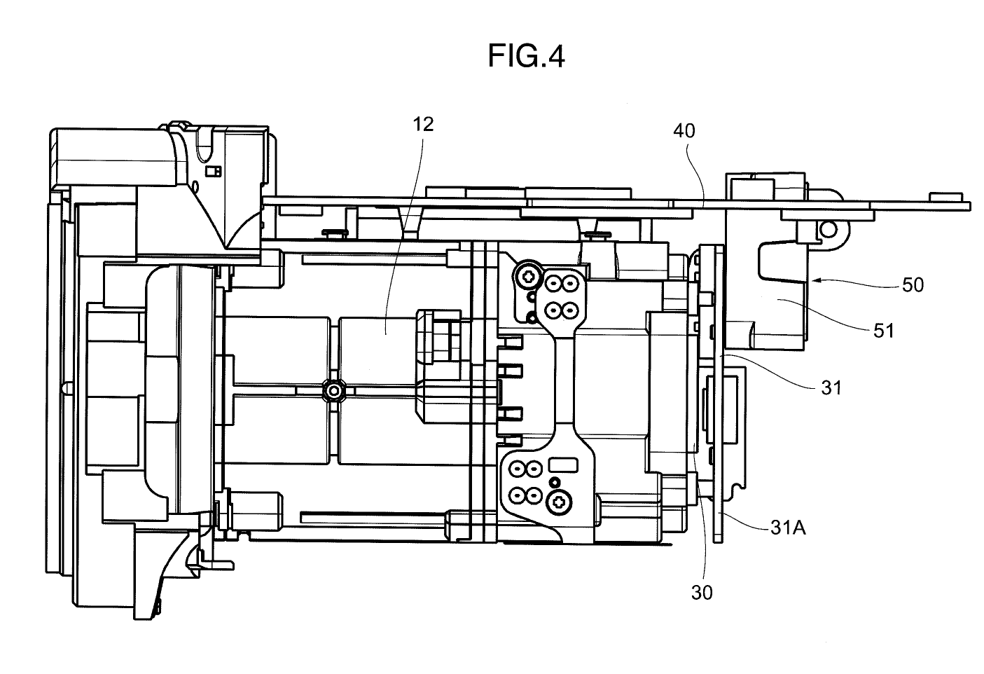

The cooling fan 50 is arranged below the rear sides of the radiating plate 31 and the main circuit board 40 with a predetermined spacing from the radiating plate 31 and the main circuit board 40. The cooling fan 50 includes a case 51 in the form of a substantially rectangular parallelepiped and fins arranged in the case 51 (the fins are not shown in the drawings to definitely indicate the positional relationship with other members). In particular, as shown in FIGS. 4 to 6, the cooling fan 50 is arranged in a space defined between the bottom of the housing 11 and the rear side of the main circuit board 40 so that a right side thereof is positioned on the right of the main circuit board 40.

The left side of the cooling fan 50 is arranged in a space, which is formed by the other end 31B of the radiating plate 31 being positioned toward the front side. That is, in particular, as shown in FIG. 5, the cooling fan 50 is put in a state, in which a left, upper portion thereof as viewed from the rear side overlaps the radiating plate 31, and in a state, in which a right side thereof overlaps the main circuit board 40, and a plane (surface) thereof as viewed from the rear side of the other end 31B of the radiating plate 31 is made substantially perpendicular to a direction of the air flow. Accordingly, when the cooling fan 50 is driven to generate an air flow, an air is introduced into the housing 11 from the intake port 29 and a part of an air flow generated thereby strikes directly against the main circuit board 40 and flows along a plane (surface) of the main circuit board 40 as viewed from the right side to be discharged outside the housing 11 from the exhaust port 19. In this manner, the surface of the main circuit board 40 defines a flow passage of a part of the air flow. Also, another part of the air flow strikes directly against the surface of the other end 31B of the radiating plate 31. As described above, the air flow can efficiently cool the radiating plate 31 and the main circuit board 40.

In addition, the embodiment uses a suction type fan, by which an outside air is sucked into the housing 11, as the cooling fan 50. Also, since the cooling fan 50 is arranged on the rear side and the microphone 13 is arranged on the front side to separate positions, in which the both are arranged, from each other, sound generated by driving the cooling fan 50 is prevented from being collected by the microphone 13. Also, since an air flow generated by driving the cooling fan 50 flows to the front side from the rear side to be discharged outside from the exhaust port 19, an air flow (air) as discharged is prevented from striking against a photographer.

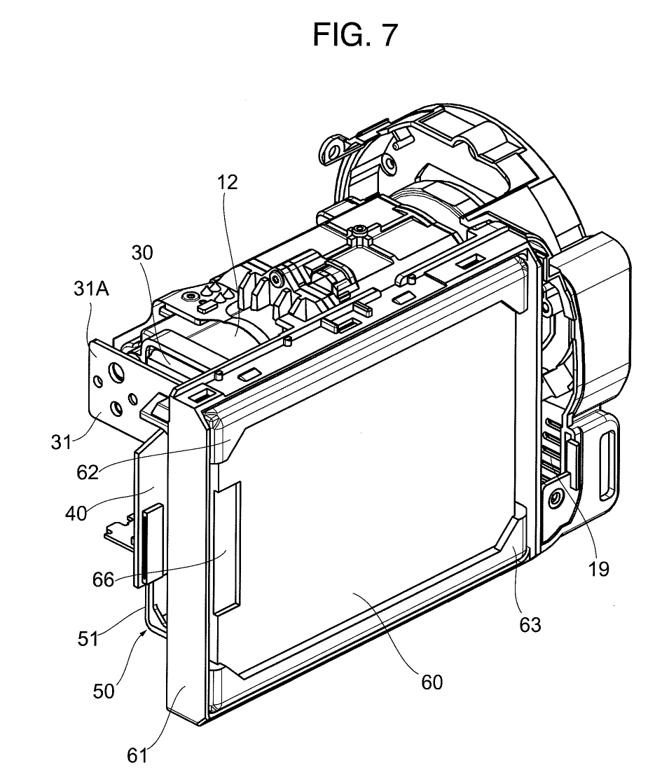

Also, as shown in FIGS. 7 to 10, a HDD 60 arranged in a case 61 is arranged on the right of the main circuit board 40. A damper 62 is arranged at an upper end of the HDD 60 and a damper 63 is arranged at a lower end thereof. Also, a flexible printed circuit board 65 (referred below to as “FPC 65”) is connected to an upper portion of the HDD 60 on the rear side. The FPC 65 branches into a HDD flexible printed circuit board 66 (referred below to as “HDD FPC 66”) for connecting the HDD 60 to the main circuit board 40 and an SD flexible printed circuit board 67 (referred below to as “SD FPC 67”) for connecting an SD circuit board 70, described later in detail, to the main circuit board 40. Since the FPC 65 is positioned above the main circuit board 40 and the HDD 60, it does not inhibit an air flow generated from the cooling fan 50 from flowing, so that the air flow can further efficiently cool the radiating plate 31 and the main circuit board 40. In addition, for the sake of showing the structure clearly, FIG. 7 shows a state, in which the FPC 65 is omitted, and FIGS. 10 to 13 show in a state, in which the case 61 is omitted.

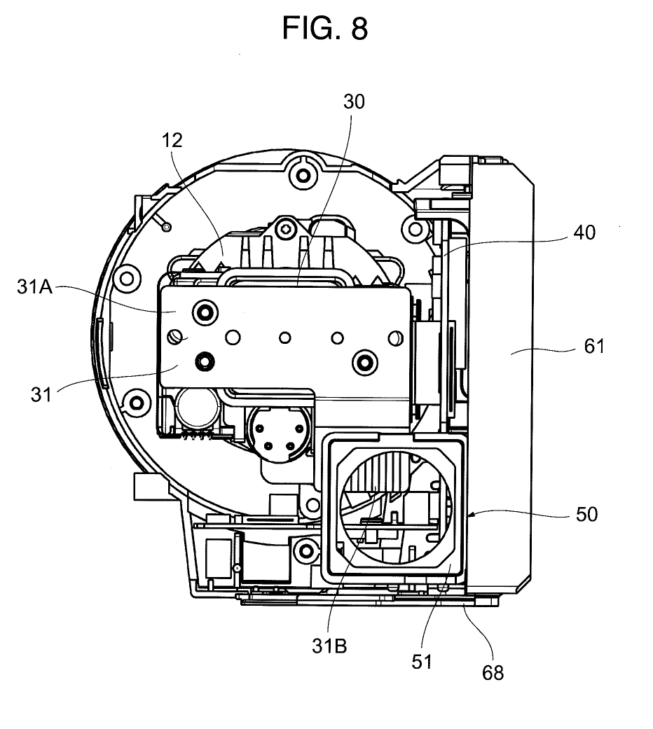

As shown in FIGS. 8, 16, and 17, a stationary plate 68 extending leftward is formed at a lower end of the case 61 to fix the case 61 to a bottom surface of the housing 11.

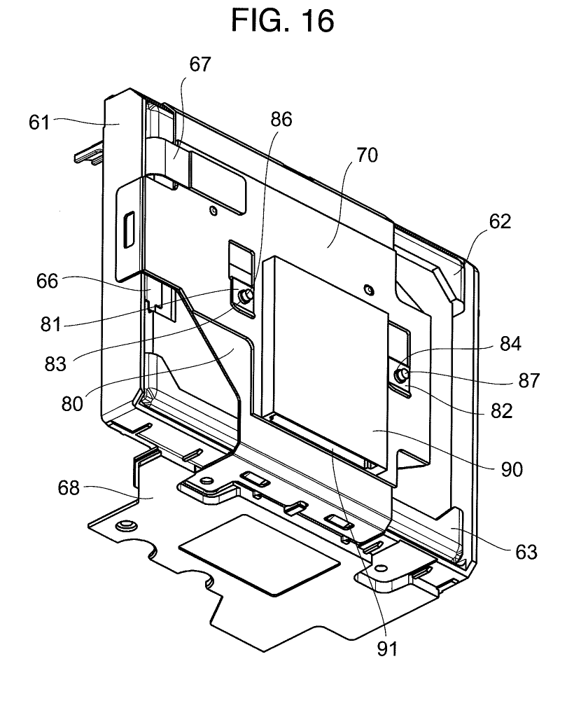

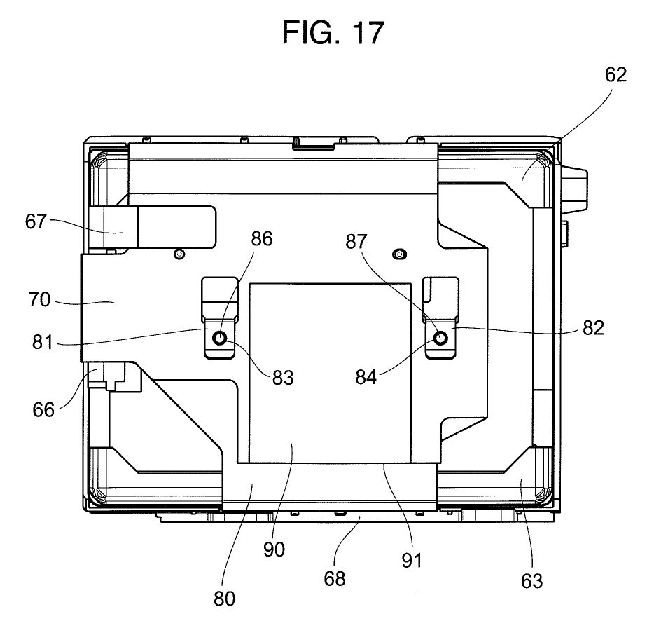

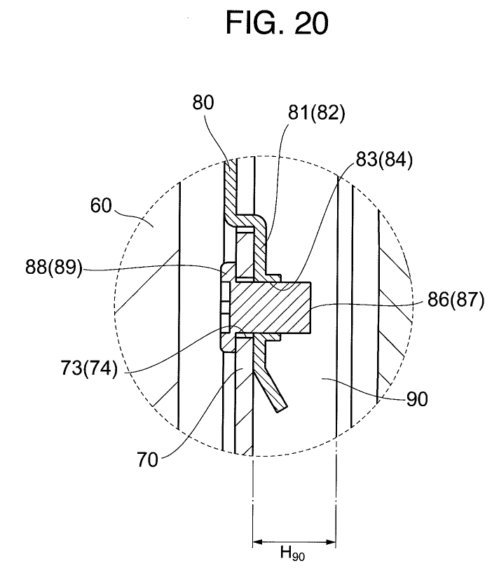

As shown in FIGS. 16 and 17, an SD frame 80 is mounted to the case 61, in which the HDD 60 is accommodated. The SD frame 80 is supported at upper, lower, and rear side ends of the case 61. Also, an SD circuit board 70 is arranged on the SD frame 80 and an SD connector 90, into which an SD card is inserted in an insertable and detachable manner, is arranged substantially centrally of the SD circuit board 70. Stationary pieces 81, 82 for fixing the SD circuit board 70 are formed on both sides in a longitudinal direction (both sides in a left and right direction in FIG. 17), which correspond to a position, in which the SD connector 90 of the SD frame 80 is arranged, and on a depth side in a direction, in which an SD card is inserted. The stationary pieces 81, 82 project substantially the same height as a thickness of the SD circuit board 70 from a plane (surface) as viewed from the right side of the SD frame 80, so that as shown in FIG. 20, the SD circuit board 70 is inserted between the surface of the SD frame 80 and the stationary piece 81 and between the surface of the SD frame 80 and the stationary piece 82. Also, threaded holes 83, 84, respectively, are formed substantially centrally of the stationary pieces 81, 82.

As shown in FIGS. 16 and 17, the SD FPC 67 is connected to an upper portion of the SD circuit board 70. The SD circuit board 70 is slid and inserted between the surface of the SD frame 80 and the stationary piece 81 and between the surface of the SD frame 80 and the stationary piece 82 to be arranged on the SD frame 80. Threaded holes 73, 74, respectively, are formed on the SD circuit board 70 to be positioned to overlap the threaded holes 83, 84, respectively, formed on the stationary pieces 81, 82 when the SD circuit board is arranged on the SD frame 80 (see FIG. 20). Screws 86, 87, respectively, are inserted into the threaded hole 73 and the threaded hole 83 and into the threaded hole 74 and the threaded hole 84 from a side of the SD frame 80 to be screwed into the threaded holes whereby the SD circuit board 70 is fixed to the SD frame 80. In this manner, the screws 86, 87 are inserted and fixed from the side of the SD frame 80 whereby heads 88, 89 of the screws 86, 87 are directed toward the HDD 60.

As shown in FIG. 20, since thicknesses of the heads 88, 89 of the screws 86, 87 can be made shorter than lengths of tip ends of the screws 86, 87 projecting from the stationary pieces 81, 82, a space defined between the HDD 60 and the SD frame 80 can be made smaller as compared with the case where screwing is accomplished from a side of the SD circuit board 70. Further, since the stationary pieces 81, 82 project substantially the same height as the thickness of the SD circuit board 70 from the surface of the SD frame 80 and the SD circuit board 70 is positioned between the stationary pieces 81, 82 and the SD frame 80, it is possible to separate the heads 88, 89 further from the HDD 60. Accordingly, it is possible to make the housing 11 thin in a left and right direction. Also, since the heads 88, 89 are larger in diameter (that is, larger in area) than the tip ends of the screws 86, 87, a shock on the HDD 60 can be decreased even if the HDD 60 comes into contact with the heads 88, 89, as compared with the case where the tip ends of the screws 86, 87 come into contact with the HDD.

When the SD circuit board 70 is fixed to the SD frame 80, the tip ends of the screws 86, 87 project from the stationary pieces 81, 82 as shown in FIG. 20 but are positioned (toward the SD circuit board 70) to have a smaller height than a thickness H₉₀ (see FIG. 20) of the SD connector 90 arranged on the SD circuit board 70, so that a space, in which the SD circuit board 70 is arranged, can be made use of as a space, which accommodates for projection of the screws 86, 87. Accordingly, projection of the screws 86, 87 has no adverse influence on miniaturization of the device. In addition, an insertion/drawing-out port 91, through which a SD card is inserted/pulled out, is defined on a lower surface of the SD connector 90.

As shown in FIGS. 16 and 17, both longitudinal sides (that is, both sides substantially perpendicular to the direction, in which a SD card is inserted) of an upper portion of the SD connector 90 are fixed by means of the screws 86, 87. Here, when an SD card is inserted into or pulled out from the SD connector 90, a stress is liable to act on the SD frame 80 and the SD circuit board 70 in a region on the both sides of the SD connector 90 substantially perpendicular to the direction, in which an SD card is inserted, and on a side in a direction of SD card insertion, but it is possible to prevent the SD frame 80 and the SD circuit board 70 from being deflected by the stress since the screws 86, 87 are positioned in the region.

Also, since the SD connector 90 is arranged outwardly of the HDD 60, it can be arranged making use of an internal space defined by the grip portion 17 curved outwardly of the housing 11, so that it is possible to make the housing 11 thin in the left and right direction, thus enabling attaining miniaturization. Also, since the SD connector 90 is arranged outwardly of the HDD 60, it is possible to arrange the SD connector 90 in a position distant from heat generating parts such as the image pickup device 30, the main circuit board 40, etc. Therefore, an SD card inserted into the SD connector 90 can be protected from heat generated from the heat generating parts. Further, the SD frame 80 is arranged outwardly of the HDD 60 whereby it is possible to protect the HDD 60 from an external environment.

Also, since the HDD 60 and the SD circuit board 70 are adjacent to each other, the HDD FPC 66 and the SD FPC 67 can be combined to be the FPC 65 for connecting to the main circuit board 40, so that wiring is not made complex and a space, in which the FPC 65 is arranged, can also be made small.

In addition, while the embodiment has been described with respect to the case where the cooling fan 50 is arranged in a position, in which a direction of an air flow generated from the cooling fan 50 is made substantially parallel to the surface of the main circuit board 40, it is not limited thereto. The cooling fan 50 may be arranged and inclined at need so that the air flow strikes against the surface of the main circuit board 40 in an oblique direction thereto. Also, the cooling fan 50 may be arranged and inclined so that the air flow strikes against the surface of the radiating plate 31 in a direction of an acute angle thereto (or in a direction of an obtuse angle thereto).

Also, while the embodiment has been described with respect to the case where the cooling fan 50 is arranged below the rear side of the housing 11, it is not limited thereto. The cooling fan 50 may be arranged in another position, for example, above the rear side, provided that a flow passage of at least a part of an air flow generated by the cooling fan 50 is defined by the surface of the main circuit board 40, or the air flow strikes directly against the surface of the radiating plate 31, or the both described above can be met.

Also, while the embodiment has been described with respect to the case where the suction type cooling fan 50, by which an outside air is sucked into the housing 11, is used, it is not limited thereto. A discharge type cooling fan, by which an inside air in the housing 11 is discharged outside, may be used. In case of using the discharge type cooling fan, the cooling fan is desirably arranged on the front side of the housing 11 in order to prevent an air discharged from an interior of the housing 11 from striking against a photographer.

Also, according to the embodiment, while the grip portion 17 is formed on the right of the housing 11 and in order to arrange the SD connector 90 making use of a space formed by the grip portion 17, the SD connector 90 is arranged on the right of the main circuit board 40 with the HDD 60 therebetween, it is not limited thereto. The SD connector 90 may be arranged in another position provided that it is arranged on an opposite side of the HDD 60 to heat generating parts such as the image pickup device 30, the main circuit board 40, etc. For example, in the case where the grip portion is formed on the left in order to permit the left hand to grip the housing 11, it is possible to arrange the SD connector 90 on the left of the main circuit board 40 with the HDD 60 therebetween.

It should be further understood by those skilled in the art that although the foregoing description has been made on embodiments of the invention, the invention is not limited thereto and various changes and modifications may be made without departing from the spirit of the invention and the scope of the appended claims.

1. An information record and reproduction device that records and/or reproduces information from both a hard disk and a card-shaped recording medium, the information record and reproduction device comprising:
a housing;
a hard disk drive arranged in the housing; and
a connector for a card-shaped recording medium, arranged in the housing, and
wherein a side of the housing defines a grip portion being grasped by a user, and
the connector for a card-shaped recording medium is arranged toward the grip portion relative to the hard disk drive.

2. The device according to claim 1, further comprising a main circuit board which is arranged in the housing and on which an integrated circuit for processing a signal is mounted, and
the hard disk drive is arranged between the circuit board and the connector for a card-shaped recording medium.

3. The device according to claim 1, further comprising a circuit board for a card-shaped recording medium, on which the connector for a card-shaped recording medium is mounted, and
a frame, to which the circuit board for a card-shaped recording medium is fixed, and
wherein the circuit board for a card-shaped recording medium is screwed to the frame from a side toward the hard disk drive.

4. The device according to claim 3, wherein the circuit board for a card-shaped recording medium is screwed to the frame in positions in the vicinity of both sides of the connector for a card-shaped recording medium, which sides are substantially perpendicular to a direction, in which the card-shaped recording medium is inserted.

5. The device according to claim 4, wherein the circuit board for a card-shaped recording medium is screwed to the frame deep in the connector for a card-shaped recording medium, in a direction, in which the card-shaped recording medium is inserted.

6. The device according to claim 3, further comprising a case that receives the hard disk drive and is fixed to the housing, and
wherein the frame is fixed to a side of the case, which receives therein the hard disk drive, toward the grip portion.

7. The device according to claim 3, wherein the hard disk drive and the circuit board for a card-shaped recording medium are connected to the main circuit board by means of a flexible printed circuit board and a side of the flexible printed board connected to the hard disk drive and the circuit board for a card-shaped recording medium branches into two portions, the two portions, respectively, being connected to the hard disk drive and the circuit board for a card-shaped recording medium.
